(19) United States
(12) Patent Application Publication
(10) Pub. No.: US 2016/0206998 A1
(43) Pub. Date: Jul. 21, 2016

(54) TIDAL ENERGY SEAWATER DESALINATION SYSTEM

(71) Applicants: Rachanida NIMMANOP, Nuku'alofa (TO); William SANFT, Nuku'alofa (TO)

(72) Inventor: William SANFT, Nuku'alofa (TO)

(21) Appl. No.: 14/913,106

(22) PCT Filed: Aug. 21, 2013
(86) PCT No.: PCT/IB2013/056767

§ 371 Date: Feb. 19, 2016

(51) Int. Cl. B01D 61/02; B01D 61/08; B01D 61/10; C02F 1/44

(52) U.S. Cl. CPC B01D 61/025; C02F 1/441; B01D 61/08; B01D 61/10; C02F 2103/08

(57) ABSTRACT

A submerged Bladder with a floor level fixed to a height the same as or just below the lowest low tide level has flexible side-walls and a ceiling which is fixed to a floating Buoy. The Bladder flexible walls have a height that is slightly over the length of the lowest low tide level and the highest high tide level. Seawater desalination membranes are fixed under the floor or integrated into the floor. As the tide rises, the Buoy rises with it. The rising Buoy causes the Bladder to open up. As the Bladder opens up, seawater is pulled into the Bladder to fill the new space available inside the Bladder. The seawater is desalinated as it travels through the membranes, and enters the Bladder as desalinated potable water. At peak high tide mark, the Bladder outlet pipe is opened to drain the contents of the Bladder to an on-shore Reservoir. During the draining process, an air-lock valve on top of the Bladder is opened to aid drainage of water. This operation takes place twice a day consistent with tidal flow, every day, for any volume of water, with no cost for external power source.

### TECHNICAL FIELD

This invention relates to a method by which to change seawater into potable or drinkable water. The field of endeavour that the invention pertains to is therefore that of seawater desalination systems. The invention particularly concerns a system that is powered by one of the forces of nature, and requires no other external power source for the operation of the system.

### BACKGROUND ART

The following prior art methods are the main systems used to desalinate seawater. They both require an external power source to drive the operation of the machinery involved in the process.
a) Reverse Osmosis Desalination
b) Distillation Desalination

In a typical Reverse Osmosis Desalination system, a compressor is used to push seawater from one compartment through the membranes into another compartment at a pressure of about 1,200 psi. Where Distillation is the method of desalination, the water must be heated up before the system can produce the steam to begin the distillation process.

### BRIEF DESCRIPTION OF THE NEW INVENTION

Seawater is desalinated by means of energy harnessed from the rise of the tide to cause seawater to be forced through seawater desalination membranes into a Bladder, and then using the descending tide and gravity to drain the desalinated water from the Bladder through an outlet pipe connected at the bottom of the Bladder to an on-shore reservoir.

### SUMMARY OF THE INVENTION

### Prior Art Problem

In the Reverse Osmosis Desalination System, the motor which drives the compressor must be powered by an external energy source. Likewise in Distillation Desalination Systems, the heater elements must be powered by an external energy source.

### Solution to the Problem

As will be described in more detail hereinafter, the Tidal Energy Seawater Desalination System harnesses power from nature to supply the energy required for the operation of the system, and therefore does not require an external energy source.

### Competitive Advantages of the New Invention

Since the Tidal Energy Seawater Desalination System does not require an external power source, the daily running costs for the operation of the system are next to none. The only costs will be ongoing maintenance of the parts once or twice a year, and the salary of one employee, whether for large or for small systems, to monitor the operation of the system.

The new invention, unlike the above mentioned prior art systems which require an external power source, does not emit carbon dioxide into the atmosphere, and produces no toxic waste products. The operation of the new system is environmentally harmonious and therefore ideal for any ocean-side location.

The initial capital cost for the main components of the Tidal Energy Seawater Desalination System, and the maintenance costs, will be minimal relative to that of prior art systems.

### DETAILED DESCRIPTION OF THE INVENTION

The Tidal Energy Seawater Desalination System works together with the moon cycle and its effects on the ocean tide. The twice daily rise and fall of the tide equates with the twice daily filling of desalinated water into the Bladder and draining of that water through an outlet pipe to reservoir tanks on shore. The system therefore can fill the Bladder up with desalinated water twice a day using energy from the moon cycle, and send it to shore using energy from gravity. One filling process of the Bladder takes about six hours during the time between low tide and high tide, and likewise one draining process of the Bladder takes about six hours during the period between high tide and low tide, or less depending on the Outlet Pipe diameter. The system is thus in harmony and driven by the rise and fall of the tide.

The rise of the tide causes a Float Buoy to rise with it. The Float Buoy is connected to the ceiling of a submerged Bladder. The Bladder is fixed to a Bladder Floor which is part of the Structure that is fixed to the Seabed. Seawater desalination Membranes are connected to the Bladder Floor from underneath. The rest of the Bladder is air-tight except for an air-lock valve on top of the Bladder which is closed during the filling of the Bladder and opened during the draining of the Bladder. When the Float Buoy rises with the tide, the Bladder, whose ceiling is connected to the Float Buoy, is forced open. As the Bladder opens, this action forces water through the membranes to fill the newly created space inside the Bladder caused by the rising Float Buoy. At the peak High-Tide mark twice a day, the Bladder will be full of desalinated water ready for draining through the outlet pipe into the on-shore Reservoir tanks.

The height of the Bladder from stationary Bladder Floor to the Bladder Ceiling fixed to the Float Buoy is the most important length in the system, and to account for margin of error from meteorological predictions, should be slightly more than the length of the difference between the highest peak High-Tide mark and the lowest peak Low-Tide mark, as forecasted by Meteorologists for the period and location in future that the system will be in operation. This is in order to ensure that the components of the system are not damaged, which may occur if the bladder height were less than this abovementioned recommended length, since the Float Buoy would be slightly submerged at the peak High-Tide mark exerting strain on the structure and components. If the bladder height is too excessive, unnecessary air will be inside the Bladder, lessening the suction force required to pull the seawater through the Membranes as the Float Buoy ascends with the tide.

The fixed horizontal Bladder Floor level of the Bladder should be the same as or several millimetres below the lowest annual Low-Tide Mark as projected for the period and location the system will be in operation, in order to ensure that the maximum amount of water can be desalinated during the filling process. If the floor level is too high above the lowest Low-Tide mark, the system will not be producing efficiently in terms of optimum volume of seawater that can be desalinated into the Bladder during one filling cycle as the Float Buoy forces the Bladder open on its rise to the High-Tide level.

The Bladder can be any shape, cylindrical, cubic or otherwise. It must have flexible sides to allow for the Bladder to open up as the Float Buoy rises with the tide. The Bladder Floor must be stationary and a part of the main Structure fixed to the Seabed. The Bladder Ceiling is fixed to the Float Buoy. The materials used for the components can be as stated here, or any other material with similar properties.

The Bladder can be any size and therefore volume, and will depend on how much water the system is required to produce. A Bladder can be as small as one cubic metre producing 1,000 litres twice a day, or 10,000 cubic metres producing 10,000,000 litres twice a day. The main difference between large and small volume systems is the number of filter membranes that can fit underneath the stationary Bladder Floor. Instead of separate filter membranes plumbed onto the underside of the Bladder Floor, as shown in the drawings, the entire stainless steel Bladder Floor could be designed to have the filter membranes integrated into the floor; the pores dissecting the stainless steel Bladder Floor, and the filter membranes adjacent and underneath the stainless steel Floor.

The ideal location for the new invention should be where the Seabed is about minimum one and a half metres below the lowest Low-Tide mark so that the one metre long filter Membranes (which is a standard length of currently available filter Membranes manufactured by several companies) fixed to and underneath the stainless steel Bladder Floor have a distance of about half a metre between their lowest point and the Seabed. If the height between Bladder Floor and the Seabed is not long enough, then the Seabed will have to be excavated to allow for the Structure, Outlet Pipe, Protective Net and Membranes to fit underneath the Bladder Floor. The Membranes can be positioned horizontally instead of vertically, by means of an elbow joint between the Bladder Floor and the Membrane, if there is not enough room underneath the Bladder Floor for vertical positioning. The best site location is directly beside or as close as possible to the shoreline. As mentioned as an option above, the filtration membrane can be integrated into the Bladder Floor, whereby existing manufacturers of seawater filtration membranes can adopt the same design features as for their tubular membranes, but in this case ending up with a flat surfaced ‘floor integrated membrane’.

The Float Buoy surface area size in touch with the surface of the ocean water level is the second most important dimension and should have a horizontal surface area that is large enough to overcome the resistive force required to open the Bladder up and thus cause seawater to be sucked into and through the filter membranes, as the tide rises and lifts the Float Buoy with it. The larger the surface area of the Float Buoy relative to the size of the Bladder, and the number of pores on the filter membrane, the more power it will generate and therefore the easier it will be to open the Bladder up and thereby suck the seawater through the Membranes to bring desalinated water into the Bladder. The surface area required for the Float Buoy to create enough suction force to bring about the desalination process can be determined by starting with a surface area slightly larger than Bladder Ceiling horizontal surface area, and then if required, increasing it until the desalinated water begins to enter the Bladder, and the Float Buoy is not excessively submerged during the rising tide period.

Once the desalination process begins, then measurements can be recorded of all the variables involved in the process; namely: a) the surface area of the Float Buoy; b) the volume of the Bladder; and c) the number of pores on the Filter Membranes. Using these measurements, a formula can then be constructed to determine the surface area the Float Buoy must be relative to the size of the Bladder and the number of pores on the filter membranes, in order for the system to successfully force the seawater through the membranes and fill the Bladder with desalinated water.

The on-shore Reservoir Tanks receiving the desalinated water from the Outlet Pipe of the Bladder should have a ceiling height lower than the Bladder Floor, so that water can be drained into it using only gravity once the bladder is full and the Air-Lock Valves on the Bladder Ceiling and the Outlet Pipe Valve are both opened at the High-Tide mark. If the Reservoir Tanks are above the Bladder height, a pump can be employed to do the work. To simplify operations, the Bladder should be drained into Reservoir tanks using gravity only, after which it can be pumped upward to a gravity tank for further distribution.

The inner diameter of the Outlet Pipe should be large enough to allow all water to drain out from the Bladder during the six hour cycle from High-Tide to Low-Tide, in order to use only gravitational force. Since no formula exists to determine rate of flow of desalinated water from a tank through a drainpipe, trial and error can be employed. If the Outlet Pipe is too small in diameter, the Float Buoy will help push water out of the bladder as the tide falls and brings the Float Buoy downwards, exerting a squeezing pressure onto the Bladder. However, as much use as possible of gravity is recommended, so as not to cause unnecessary strain on structure and materials that would be the case if the diameter of the Outlet Pipe were too small, thus causing the Float Buoy to have to push water out of the Bladder as the tide descends.

The filtration Membranes that can be used in the new invention can be purchased from existing manufacturers of seawater desalination membranes used in Reverse Osmosis Desalination Systems such as Hydranautics, GE Water, or Filmtec. Ideally however, as abovementioned, the entire stainless steel floor of the Bladder should be a membrane. This integration of the Bladder Floor and Membrane would be a more practical design for the ‘Tidal Energy Seawater Desalination System’. The Bladder Floor Membrane would have pores in the stainless steel Bladder Floor, the same size as those pores found on existing tubes inside existing Membrane layers covering the tube, but on a flat surface. The Membrane material underneath the pores on the stainless steel Bladder Floor will also be flat surfaced. The abovementioned companies can manufacture these ‘Bladder Floor Integrated Membrane Systems’ according to specifications required by Tidal Energy Seawater Desalination System designers. The ‘Bladder Floor Integrated Membrane System’ will essentially be one part, and thus be less troublesome to maintain than several membranes plumbed onto the bottom.

In Reverse Osmosis Desalination systems, as mentioned above, a compressor is used to push the seawater through the membranes. This compressor is substituted for in the Tidal Energy Seawater Desalination System by the action of the Float Buoy rising with the tide, thereby causing a suction force that sucks the seawater in through the membranes and in to the Bladder to fill the space made available by the rising Float Buoy. The new invention therefore does not require a compressor or electrical power for any of its operations, and indeed, can operate without the optional solar panels on the Float Buoy, which are only required if additional electrical equipment is employed. An on-shore pump can be employed for example to pump desalinated water from the Bladder directly into the town water supply grid, twice a day, or to pump desalinated water from the Reservoir Tank to an overhead gravity tank for further distribution.

If Solar Panels are erected on top of the Float Buoy, electricity can be generated to a) power heating elements (which should be located as close as safely possible to the Membranes) in order to ease the pressure required to suck the seawater in through the Membranes and deliver desalinated water into the Bladder; as is the case with some prior art reverse osmosis systems which use heat to accelerate the desalination process, b) power a pump to accelerate the emptying process which starts at the peak High-Tide mark and ends at the peak Low-Tide mark, and c) to power a microprocessor to facilitate automatic switching for closing of Air-Lock Valve at peak High-Tide mark and opening of it for draining at peak High-Tide mark. Excess Power from Solar Panels on the Float Buoy can be stored in DC Batteries to power other machines on the shore facility. Wind Turbines can also be employed on the perimeter of Float Buoy to generate electricity and also as a deterrent to seabirds' droppings.

### DESCRIPTION OF DRAWINGS

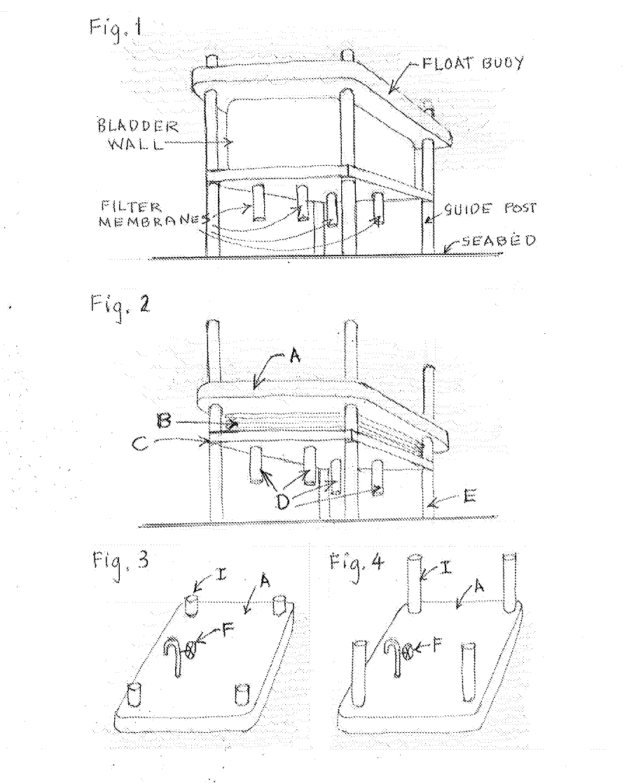

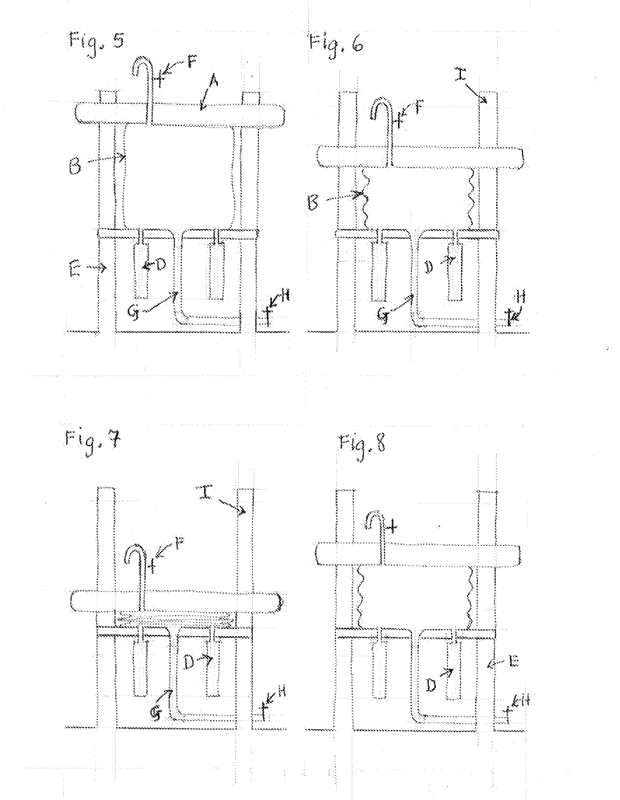

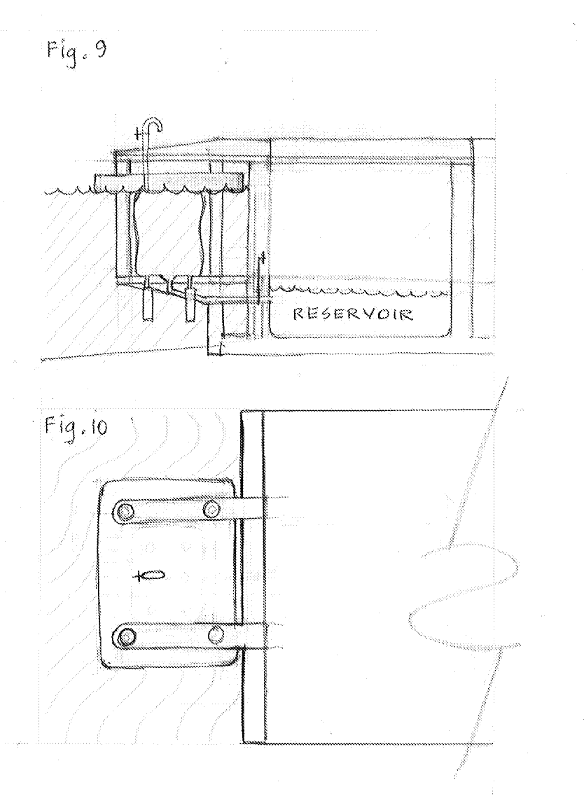

The Main Components of the Tidal Energy Seawater Desalination System, (see FIG. 1, FIG. 2, FIG. 3, FIG. 4, FIG. 5, FIG. 6, FIG. 7 and FIG. 8) consist of:
A) Bladder Ceiling (foam Float Buoy)
B) Bladder Walls (flexible PET-plastic)
C) Bladder Floor (stationary Stainless Steel Plate)
D) Seawater Desalination Membranes (fixed to Bladder Floor from underneath)
E) Structure (fixed to Seabed and Bladder Floor with Membranes in between)
F) Air-Lock Valve and Pipe (on top of Bladder Ceiling/Float Buoy)
G) Outlet Pipe (leading from under Bladder to on-shore reservoir)
H) Outlet Valve (on Outlet Pipe; opened when Bladder is full, closed when empty)
I) Guide Posts (on Structure and Guide Holes on Float Buoy to guide Bladder up and down as Bladder is filled and drained)

Some Optional Components might consist of ia.:
1) Photovoltaic Cells and Wind Turbines (on Float Buoy to run 2, 3 & 5 hereunder)
2) Pump (on Outlet Pipe to accelerate emptying of Bladder when full)
3) Heating Elements (underneath Filter Membranes to accelerate desalination)
4) Protective Net (surrounding perimeter of and underneath Membranes)
5) Microprocessor Switching (for automatic operation of systems)
6) Batteries, MMTS Solar Cell Charge Controller, Gauges and Wiring

The Operation of the system is described with illustrative diagrams at four points three hours apart during the operation of the system:

At peak High-Tide Mark, about 6 hours after peak Low-Tide Mark—(see FIG. 5)
1) The Bladder Ceiling Float Buoy stops ascending.
2) No more water will be sucked into the Bladder, which will be nearly full of desalinated water at this point.
3) The Air-Lock Valve on top of Float Buoy is opened to assist in drainage of the desalinated water.
4) The Outlet Pipe Valve on shore is opened to allow water to drain out of the Bladder using gravity and travel through the Outlet Pipe to a Reservoir tank or tanks on shore. The Reservoir should have a ceiling height lower than the Bladder Floor height so that the desalinated water can travel using gravity. If not, solar panels can be employed to power a pump system as mentioned above.

About three hours after peak High-Tide Mark with Tide still falling—(see FIG. 6)
1) The Bladder is half empty and still draining water out through Outlet Pipe using gravity.
2) The Air-Lock Valve and the Outlet Pipe Valve are kept open during the draining process until the peak Low-Tide Mark.

At peak Low-Tide Mark—(see FIG. 7)
1) The Bladder is empty of most of the water as the Float Buoy underside connected to the Bladder Ceiling is right above the Bladder Floor at peak Low-Tide Mark.
2) The Air-Lock Valve is closed at peak Low-Tide Mark ready for the ascent of the Float Buoy with the rising tide.
3) The Outlet Pipe Valve is also closed at peak Low-Tide Mark ready for the ascent of the Float Buoy.
4) As the tide begins to rise shortly after the peak Low Tide Mark, the flexible side-walls of the Bladder, whose ceiling is the Float Buoy and whose stationary Bladder Floor is connected to the main Structure fixed to the Seabed, effectively move and force open the Bladder as the Float Buoy ascends with the rising tide level. As the Bladder opens, this causes a suction of the seawater through the desalination filter Membranes, since there are no other pores on the Bladder through which air or water can enter into the Bladder to fill the space made available by the rising Float Buoy and expanding Bladder. The suction force caused by the Float Buoy ascending with the tide, if the surface area of the Float Buoy is large enough, will overcome the force required to allow travel of the saltwater through the filter Membranes and in so doing desalinating the water in the process, thus producing desalinated water to fill the Bladder up with. As mentioned above, the horizontal surface area size of the Float Buoy must be made large enough to be able to create the force required to pull the seawater in through the Membranes and into the Bladder as desalinated water.

About three hours after peak Low-Tide Mark with Tide still rising—(see FIG. 8)
1) The Bladder is about half full and still filling up as the tide rises pushing up the Float Buoy which in turn opens up the Bladder causing suction of seawater in through the filter Membranes.
2) The Air-Lock Valve and the Outlet Pipe Valve are kept closed until the High-Tide Mark.

Back to peak High-Tide Mark again, as in ‘0023a’ above—(see FIG. 5)
1) The Bladder is full again.
2) The Air-Lock Valve is opened ready for draining during Float Buoy descent.
3) The Outlet Pipe Valve is opened ready for draining
4) And so on . . . .

### Alternative Design Examples

There can be many design alternatives for the Tidal Energy Seawater Desalination System. The final design will be determined mainly by the location and environment that it is to operate in. A side mounted system of the new invention is shown in FIG. 9 and FIG. 10. The new invention is directly adjacent to a wharf structure with cantilever beams holding floor and guide posts. A deep sea oil or gas drilling platform for example could have such a system to supply its employees with fresh water twice a day. The system would not have to be too large since it would only require the daily usage plus contingency to be produced per day. The Bladder Floor of the Tidal Energy Seawater Desalination System can be fixed at the appropriate abovementioned height to the structure of the rig, and the water can be pumped up to a small reservoir on board; just enough for the daily requirements. This would save the cost of having to bring fresh water from shore, or having to desalinate by means of a compressor if reverse osmosis systems are used.

The new invention can be stationed in any location. The main requirement, as mentioned above, is that the Bladder Floor must either be directly fixed to the seabed, or fixed to another structure that is fixed to the seabed. As mentioned above, the height of the floor level must be fixed at a point just below the lowest low tide mark.

The design of each component of the system can also vary according to the specific environment it is to operate in. In locations where there is a tendency for a lot of wave action or adverse weather conditions, the Float Buoy may not need to have as much of a surface area touching the water as would be required in flat water areas, since the adverse weather conditions will improve the operation of the system, because there will be more pulling force exerted by the Float Buoy as the waves push it upwards and therefore more suction force pulling the water through the filter membranes.

### INDUSTRIAL APPLICABILITY

It is submitted that the Tidal Energy Seawater Desalination System is the most cost-effective method today to produce water, especially for ocean-side locations, or other locations where it is possible to pump the water to.

Besides being able to produce water for direct input into the grid after remineralisation, the system can also produce water for the refilling and replenishment of deep earth wells where water had once been sourced for city water supply grids.

The new invention would also be very useful in locations and islands where the seawater level has risen and damaged soil quality, and where there is an acute shortage of drinking water.

Irrigation for farms can be made possible at a very low price. Desalinated water can be doped according to the needs of a specific farm area. Deficiencies in soil quality of a given location can be added during the doping or remineralisation stage.

The new invention would also render the need to store water in large reservoirs a thing of the past, since only the daily usage, plus a contingency amount, is required to be produced every day, to fulfil the daily requirements of a given location. This will lessen significantly the need for chemicals to be added to the water supply, since fresh water at the right amount is produced every day at next to no cost. This will make for a healthier water supply.

Bringing water to desert areas to supply small townships is now feasible and viable.

Olympic size swimming pools can employ the Tidal Energy Seawater Desalination System to supply desalinated water twice a day to refresh the pool water, and will require less chemicals than conventionally built pools because the water will be plentiful.

Industries requiring an abundance of fresh water can benefit from the new invention due to the low cost of water sourcing.

A small boat or large ship can use such a system when it is anchored to supply desalinated water for on-board usage. As mentioned above, the main criteria for the system to work is that the Bladder Floor must be fixed to the seabed. Therefore, if a Bladder Floor is fixed to the anchor chain, which is fixed to the seabed, the rest of the system can operate. Such a system can begin at peak Low-Tide mark, or anytime thereafter before peak High-Tide mark, when the Bladder can then be drained onto the vessel by hand-pump or powered pump. Water on demand is therefore possible for anchored marine vessels.

This invention might contribute greatly to easing the problem in areas where there is a shortage of water; for example in the Near East, where there are ongoing disputes over the sharing of the available water.

### DRAWINGS

All drawings are drawn in a diagrammatic manner, not to scale and semi-sectioned with a view to bringing about a clear understanding of how the system operates.

FIG. 1: During the high tide mark, with the eye level looking from below the floor level.

FIG. 2: At low tide level when the Bladder is empty from the same eye level.

FIG. 3: View from above at high tide.

FIG. 4: View from above at low tide.

FIG. 5: Side View at peak high tide.

FIG. 6: Side View about half way between high and low tide.

FIG. 7: Side View at peak low tide.

FIG. 8: Side View about half way between low and high tide.

FIG. 9: Side View of side-mounted system at high tide.

FIG. 10: Top or Plan View of side-mounted system.

1. A Seawater Desalination System that is powered by one of the cyclical forces of nature. Energy from the rise of the tide is harnessed by means of a Float Buoy that stays at the same height as the sea-level connected to the ceiling of a Bladder whose walls are flexible, and whose Floor is fixed at a height the same as or just below the lowest low tide level, to pull seawater through seawater desalination membranes in to fill a bladder with potable water.

2. A Seawater Desalination System according to claim 1, wherein the Bladder Floor Level is fixed at a height the same as or slightly below the lowest forecasted low tide level for the period the System will be in operation.

3. A Seawater Desalination System according to claim 1, wherein the height of the Bladder Walls is determined by the length of the height of the highest high tide mark and the lowest low tide mark for the period the system is to operate, plus about 10-20 mm safety contingency.

4. A Seawater Desalination System according to claim 1, wherein the seawater desalination membrane is integrated into the stainless steel Bladder Floor, instead of having to plumb on to the underside of the Bladder Floor separate membranes as shown in the drawings herewith. The pores are in the stainless steel floor, and the filter membrane layers are fixed underneath the porous stainless steel Bladder Floor.

5. A Seawater Desalination System according to claim 1, wherein the Float Buoy has a surface area that is determined by the area required to pull the water through the seawater desalination membranes and into the Bladder.

6. A Seawater Desalination System according to claim 1, wherein guides are used to guide the Bladder straight up and down during the rise and fall of the tide, so as to protect the Bladder from drifting sideways from excessive currents and weather.

7. A Seawater Desalination System according to claim 1, wherein a protective net is employed to protect the filtration membranes, or membrane in the case of a membrane integrated floor, and to protect the Bladder Walls and area underneath the membranes from shells, corals and living sea mammals.

8. A Seawater Desalination System according to claim 1, wherein heater elements are employed at a safe distance from the membranes in order to aid the desalination process.

9. A Seawater Desalination System according to claim 1, wherein the yielded water is sent to an on-shore reservoir by means of gravity.

10. A Seawater Desalination System according to claim 1, wherein the yielded water is pushed or squeezed out by the descending Float Buoy as it descends with the tide.

11. A Seawater Desalination System according to claim 1, wherein an Air-Lock Valve is connected to the ceiling of the Bladder, and which Valve is closed during the filling of the Bladder as the tide rises, and opened to aid the draining of the Bladder as the tide falls

12. A Seawater Desalination System according to claim 1, wherein an Outlet Pipe connected to the Bladder Floor is employed to drain the desalinated water from the Bladder. The draining process begins at peak high tide mark and is facilitated by opening a valve on the Outlet Pipe. This valve is closed again at the low tide mark once the Bladder has been emptied and the filling process is about to start.

13. A Seawater Desalination System according to claim 1, wherein Photovoltaic Cells and/or Wind Turbines are positioned on top of the Float Buoy in order to generate electricity for on-shore pumps and facilities.

14. A Seawater Desalination System according to claim 1, wherein the surface area of the Float Buoy that is touching the surface of the ocean is determined by a formula that is constructed by starting with a Float Buoy surface area that is slightly larger than the horizontal surface area of a Bladder with a specific number of pores of a specific size and specific filter membrane resistive force, and increasing the surface area of the Float Buoy until it is large enough to effectively overcome the resistive force of the filter membranes and pores, and thereby cause the seawater to enter the Bladder through the filter membranes and pores as desalinated water.

15. A Seawater Desalination System according to claim 1, wherein the annual yield of desalinated water is determined by the horizontal surface area of the Bladder, multiplied by the average annual distance between the high and low tide marks of the location, multiplied by two daily fillings of the bladder, multiplied by 365.
